(19) United States
(12) Patent Application Publication
(10) Pub. No.: US 2024/0373276 A1
(43) Pub. Date: Nov. 7, 2024

(54) METHOD AND APPARATUS FOR DATA TRANSMISSION IN NON-CONNECTED STATE

(71) Applicant: Lenovo (Beijing) Limited, Beijing (CN)

(72) Inventors: Ran Yue, Beijing (CN); Mingzeng Dai, Shanghai (CN); Jie Shi, Beijing (CN); Min Xu, Beijing (CN); Jie Hu, Beijing (CN)

(73) Assignee: Lenovo (Beijing) Limited, Beijing (CN)

(21) Appl. No.: 18/284,482

(22) PCT Filed: Apr. 1, 2021
(86) PCT No.: PCT/CN2021/084821

§ 371 Date: Sep. 27, 2023

(51) Int. Cl. H04W 28/02

(52) U.S. Cl. CPC H04W 28/0215; H04W 28/0278

(57) ABSTRACT

Embodiments of the present application are directed to a method and apparatus for data transmission in non-connected state. The method may include: calculating a data volume for a small data transmission (SDT) transmission in a layer higher than an access stratum (AS) layer or in an AS layer; and determining to initiate an SDT procedure based on the calculated data volume being less than a data volume threshold.

### TECHNICAL FIELD

Embodiments of the present application generally relate to wireless communication technology, especially to a method and apparatus for data transmission in non-connected state.

### BACKGROUND

For a user equipment (UE) in RRC_INACTIVE state (also called an inactive mode UE), it is possible to transmit uplink (UL) small data to a base station (BS) over pre-configured physical uplink shared channel (PUSCH) resources (configured grant type 1 resources), or in an initial random access procedure, such as, 2-step random access channel (RACH) procedure or 4-step RACH procedure.

When deciding whether to initiate a small data transmission (SDT) procedure, “user data is smaller than the data volume threshold” is one of the criteria. Therefore, how to calculate the data volume needs to be considered. In addition, after initiating an SDT procedure, if a new signalling radio bearer (SRB) or data radio bearer (DRB) for SDT arrives after the first SDT transmission, how to indicate the new arrival also needs to be considered.

### SUMMARY OF THE APPLICATION

Embodiments of the present application provide a method and apparatus for data transmission in non-connected state.

Some embodiments of the present application provide a method performed by a user equipment (UE) in a non-connected state. The method may include: calculating a data volume for a small data transmission (SDT) transmission in a layer higher than an access stratum (AS) layer or in an AS layer; and determining to initiate an SDT procedure based on the calculated data volume being less than a data volume threshold.

In an embodiment of the present application, the method may further include: transmitting an indication to indicate a new data arrival with a priority equal to or lower than a priority of data for the SDT transmission after a first SDT transmission during the SDT procedure.

Some other embodiments of the present application provide an apparatus. The apparatus may include a processor; and a wireless transceiver coupled to the processor, wherein the processor is configured to: perform the method with the wireless transceiver.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of an exemplary wireless communication system according to some embodiments of the present application;

FIG. 2 illustrates a flow chart of a method for initiating an SDT procedure according to some embodiments of the present application;

FIG. 3 illustrates a simplified block diagram of an exemplary apparatus according to some embodiments of the present application; and

FIG. 4 illustrates a simplified block diagram of another exemplary apparatus according to some embodiments of the present application.

### DETAILED DESCRIPTION

The detailed descriptions of the appended drawings are intended as descriptions of preferred embodiments of the present application and are not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings.

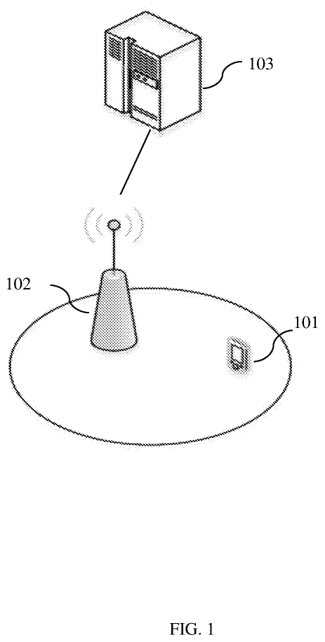

FIG. 1 illustrates a schematic diagram of an exemplary wireless communication system according to some embodiments of the present application.

As shown in FIG. 1, the wireless communication system can include at least one base station (BS), at least one UE, and a core network (CN) node. Although a specific number of BSs and UEs, e.g., a BS (e.g., BS 102) and a UE (UE 101) are depicted in FIG. 1, one skilled in the art will recognize that any number of BSs and UEs may be included in the wireless communication system. As shown in FIG. 1, the BS 102 may be distributed over a geographic region and may communicate with the CN node 103 via an interface.

The UE 101 may be a computing device, such as a desktop computer, a laptop computer, a personal digital assistant (PDA), a tablet computer, a smart television (e.g., a television connected to the Internet), a set-top box, a game console, a security system (including security cameras), a vehicle on-board computer, a network device (e.g., router, switch, and modem), or the like. According to an embodiment of the present application, the UE 101 may be a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present application, the UE 201 may be a wearable device, such as a smart watch, a fitness band, an optical head-mounted display, or the like. Moreover, the UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

The BS 102 may communicate with a CN node 103 via an interface. In some embodiments of the present application, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally part of a radio access network that may include one or more controllers communicably coupled to one or more corresponding BS(s).

In an example, the CN node 103 can be a mobility management entity (MME) or a serving gateway (S-GW). In another embodiment of the present application, the CN node 103 may include a mobility management function (AMF) or a user plane function (UPF).

The wireless communication system may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, a long term evolution (LTE) network, a 3rd generation partnership project (3GPP)-based network, a 3GPP 5G network, a satellite communications network, a high altitude platform network, and/or other communications networks.

In some embodiments of the present application, the wireless communication system is compatible with 5G new radio of the 3GPP protocol, wherein BS 102 transmits data using an OFDM modulation scheme on the downlink (DL) and UE 101 transmits data on the uplink (UL) using a single-carrier frequency division multiple access (SC-FDMA) or OFDM scheme. More generally, however, the wireless communication system may implement some other open or proprietary communication protocols, for example, WiMAX, WiFi, among other protocols.

In some embodiments of the present application, the BS 102 may communicate using other communication protocols, such as the IEEE 802.11 family of wireless communication protocols. Further, in some embodiments of the present application, the BS 102 may communicate over licensed spectrums, whereas in other embodiments, the BS 102 may communicate over unlicensed spectrums. Embodiments of the present application are not intended to be limited to the implementation of any particular wireless communication system architecture or protocol. In yet some embodiments of the present application, the BS 102 may communicate with UE 101 using 3GPP 5G protocols.

In an example, the UE 101 is not in RRC_CONNECTED state, for example, the UE could be in a RRC_IDLE state or in a RRC_INACTIVE state. When performing small data transmission, the UE 101 transmits packets to the BS 102, and the BS 102 transmits the small data to the CN node 103 via the interface.

Herein, the data transmission or small data transmission (SDT) may mean that a UE in an inactive state/mode or an idle state/mode could transmit the data to the network side (or network), or receive the data from the network side. The data transmission may include at least one of an uplink (UL) data transmission and downlink (DL) data transmission. After the completion of the data transmission, the inactive or idle UE may receive a suspend message or release message from the network and then go back to the inactive or idle mode. In some other embodiments of the present application, after the completion of the data transmission, the inactive or idle UE may receive a suspend message or release message from the network and the UE may still stay in inactive or idle mode during the data transmission procedure. In some embodiments of the present application, the suspend message or release message is a radio resource control (RRC) message.

Currently, when deciding whether to initiate an SDT procedure, “user data is smaller than a data volume threshold” is one of the criteria. Therefore, the UE should calculate the data volume of the user data, and then compare the calculated data volume with the data volume threshold. If the comparison result meets the criteria, the SDT procedure may be initiated.

According to the current agreements, after the UE decides to initiate an SDT procedure, the UE resumes the DRB(s) or SRB(s) for SDT. However, before the DRB(s) or SRB(s) for SDT is resumed, the data will not arrive at the access stratum (AS) layer, then it is not feasible to calculate the data volume in the AS layer. The AS layer is the layer lower than radio resource control (RRC) layer, such as, packet data convergence protocol (PDCP) layer, radio link control (RLC) layer, medium access control (MAC) layer, and physical (PHY) layer.

Then how to calculate the data volume including the SRB(s) and/or DRB(s) for SDT when deciding whether to initiate an SDT procedure should be defined reasonably.

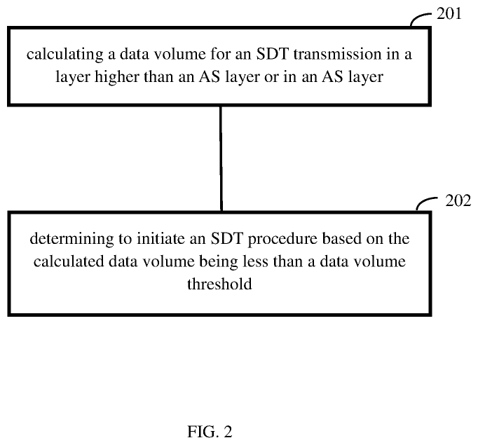

FIG. 2 illustrates a flow chart of a method for initiating an SDT procedure according to some embodiments of the present application. The method in FIG. 2 is performed by a UE (e.g., UE 101 in FIG. 1).

As shown in FIG. 2, in operation 210, the UE may calculate a data volume for an SDT transmission (an SDT transmission may include a single UL or DL small data transmission or include multiple UL or DL small data transmissions) in a layer higher than the AS layer or in the AS layer. In operation 220, the UE may determine to initiate an SDT procedure based on the calculated data volume being less than a data volume threshold. The details of the operations will be described below in conjunction with the specific embodiments.

In an embodiment, the UE calculates the data volume for the SDT transmission in a layer higher than the AS layer. The AS layer is the layer lower than RRC layer and starts from PDCP layer. That is, the data volume may be calculated in an upper layer which is higher than PDCP layer.

The data volume may include the data volume of an RB including an SRB and/or a DRB. The SRB may include at least one of SRB0, SRB1, SRB2, or SRB3.

In an example, the UE may calculate the data volume for the SRB in non-access stratum (NAS) layer. The data volume for the SRB may be at least one of a size of a NAS message, a control plane (CP) message, or a measurement report. For example, if SRB2 is a measurement report, the NAS message may be the measurement report itself. The CP message may be the measurement report plus header information or other information.

Furthermore, in an example, the data volume may only include the data size of a kind of SRB, such as, SRB2, which is configured to be allowed to do SDT. In another example, the data volume may include the data size of all the SRBs (including SRB0, SRB1, SRB2, and SRB3) which are configured to be allowed to do SDT.

The UE may calculate the data volume for DRB(s) which are configured to be DRB(s) for SDT to initiate an SDT procedure, in an upper layer which is higher than PDCP layer. The upper layer may be at least one of user datagram protocol (UDP) layer, internet protocol (IP) layer, transmission control protocol (TCP) layer, or application layer. The upper layer may calculate the data size of the user plane protocol data unit (PDU) (s) delivered to itself with or without the data size of the corresponding header(s).

In order to determine whether to initiate an SDT procedure, the UE will compare the calculated data volume with a data volume threshold, and if the calculated data volume is less than the data volume threshold, the SDT procedure will be initiated.

In some embodiments of the present application, there may be one or more thresholds and each for which radio bearer (RB) to initiate an SDT procedure can be configured, such as, one threshold for SDT DRB(s) and one threshold for SDT SRB(s) to decide whether to initiate an SDT procedure.

In particular, the data volume threshold may include at least one of a first threshold, a second threshold, and a third threshold. The first threshold, a second threshold, and/or a third threshold may be configured by a BS or be pre-configured in the UE.

In an example, if the sum of the data volume of the SRB and the DRB is less than the first threshold, the SDT procedure will be initiated.

In another example, if the data volume of the SRB is less than the second threshold, the SDT procedure will be initiated.

In another example, if the data volume of the DRB is less than the third threshold, the SDT procedure will be initiated.

In some other examples, if only one threshold is configured, whether to add the data volume of the SRB and the data volume of the DRB to calculate the data volume for the SDT transmission may be configured by the BS or pre-defined/pre-configured in the UE (that is, by default).

In another embodiment, the UE calculates the data volume for the SDT transmission in the AS layer. PDCP layer may receive data size information of the SDT transmission from an upper layer, and then the AS layer may calculate the data volume for the SDT transmission.

In an example, for SDT DRBs and/or SDT SRBs, after receiving the data size related information for SDT DRBs and/or SDT SRBs from the upper layer which is higher than PDCP layer, PDCP layer calculates the data volume.

Further, the UE may calculate the data volume for the SDT transmission by adding the data size of the SDT transmission notified from the upper layer to data size of header(s) associated with the AS layer. It is configurable for the specific AS layer. For example, if PDCP layer is configured to produce a result (that is, the PDCP layer is configured to calculate the data volume), only the size of PDCP header is added to the data size notified by the upper layer. If MAC layer is configured to produce a result, the size of MAC header and/or RLC header and/or PDCP header are added to the data size notified by the upper layer, and so on.

In some other embodiments, the UE calculates the data volume for an SDT transmission in RRC layer after receiving data size information of the SDT transmission from an upper layer. The data volume is equal to the data volume indicated or notified by its upper layer, for example, NAS layer.

In some other embodiments, there may be other criteria to determine the initiation of an SDT procedure, or the data volume threshold for the SDT transmission may not be configured to determine the initiation of SDT. Accordingly, the UE may determine whether to initiate an SDT procedure based on the other criteria which needs to be used.

Further, there could be a scenario in an SDT procedure, that is, a new data (SRB and/or DRB for SDT) arrives after the first SDT transmission (if the UL grant is not sufficient to transmit all of the data or if the UL grant is not sufficient to transmit all of the data which arrives before the SDT is initiated, there will be multiple UL or DL transmissions. If the UL grant can transmit all of the data, the single SDT PDU/packet transmitted is the first SDT transmission) in the SDT procedure. It is beneficial to multiplex the new arrival data for SDT with the ongoing subsequent SDT transmission from the perspective of signaling overhead and latency.

Currently, if the new data arrival with a higher priority than a priority of data for an SDT transmission in an SDT procedure, a new buffer status report (BSR) may be triggered. Once the new BSR is triggered, the BSR will be transmitted to the network. After receiving the BSR, the network will know the new data arrival and allocate corresponding additional resource for scheduling the new data.

However, currently, if the new data (SRB and/or DRB for SDT) with a priority equal to or lower than a priority of data for the SDT transmission arrives, which cannot trigger a BSR. Thus, the new arrival data cannot be transmitted and could be discarded eventually.

For example, in the case that SRB2 for SDT arrives, the priority of SRB2 could be 3 as configured by the default SRB2 configuration. Then the priority of SRB2 may be higher or lower than the priority of SDT DRB for the SDT transmission if following the legacy principle for SRB2 configuration. Also, in legacy, SRB0, 1 and 2 are configured to the same logical channel group (for example, logicalChannelGroup 0). After the first data transmission of the SDT DRB, the measurement report arrives (assuming the priority of SRB2 for the measurement report is lower than the first transmitted SDT DRB), there is not any BSR trigger condition satisfied if the padding bits are not sufficient for the padding BSR. The similar issue occurs after the first SDT SRB or DRB is transmitted and the new SDT DRBs with a lower priority arrives.

Therefore, how to indicate to a BS the new data arrival with a priority equal to or lower than a priority of data for an SDT transmission during an SDT procedure needs to be considered.

In some embodiments of the present application, the UE may transmit to the BS an indication to indicate the new data arrival with a priority equal to or lower than a priority of data for the SDT transmission after the first SDT transmission during the SDT procedure.

It should be understood that in some embodiments of the present application, the transmitting of the indication to indicate the new data arrival with a priority equal to or lower than a priority of data for the SDT transmission may be performed after operation 202 in FIG. 2. That is, after determining to initiate an SDT procedure based on the method in FIG. 2, the UE performs the indicating of the new data arrival.

However, in some other embodiments of the present application, the transmitting of the indication to indicate the new data arrival may be performed independently from the method as shown in FIG. 2. That is, indicating the new data arrival to the BS is irrelevant to how to initiate an SDT procedure or how to calculate the data volume. For example, in some cases, there may be other criteria to determine the initiation of an SDT procedure, or the data volume threshold for an SDT transmission may not be configured to determine the initiation of SDT.

The following will describe the indicating of the new data arrival with a priority equal to or lower than a priority of data for an SDT transmission in detail in conjunction with the specific embodiments.

In an embodiment, a new media access control (MAC) control element (CE) may be used to indicate the data arrival from a logical channel with a priority lower than or equal to a priority of a logical channel of the data for an SDT transmission. The UE may transmit the new MAC CE to the BS to indicate the new data arrival.

Furthermore, a logical channel priority (LCP) of the MAC CE may be defined. In particular, the priority of the new MAC CE may be any priority in the logical channel priority list in section 5.4.3 in 3GPP 38. 321 as below:

Logical channels shall be prioritized in accordance with the following order (highest priority listed first):
cell radio network temporary identifier (C-RNTI) MAC CE or data from uplink-common control channel (UL-CCCH);
Configured Grant Confirmation MAC CE or beam failure recovery (BFR) MAC CE or Multiple Entry Configured Grant Confirmation MAC CE;
Sidelink Configured Grant Confirmation MAC CE;
listen before transmit (LBT) failure MAC CE;
MAC CE for sidelink (SL)-BSR prioritized according to clause 5.22.1.6;
MAC CE for BSR, with exception of BSR included for padding;
Single Entry power headroom report (PHR) MAC CE or Multiple Entry PHR MAC CE;
MAC CE for the number of Desired Guard Symbols;
MAC CE for Pre-emptive BSR;
MAC CE for SL-BSR, with exception of SL-BSR prioritized according to clause 5.22.1.6 and SL-BSR included for padding;
data from any Logical Channel, except data from UL-CCCH;
MAC CE for Recommended bit rate query;
MAC CE for BSR included for padding;
MAC CE for SL-BSR included for padding.

In an example, LCP of the MAC CE may be lower than a priority of a MAC CE for BSR (with exception of BSR included for padding) and higher than a priority of the data from any logical channel (except data from UL-CCCH).

The new MAC CE may further indicate at least one information on the new data arrival: the new data arrival is for which radio bearer (RB); the data volume of the new data; or an indication to indicate whether the data volume of the new data is less than a threshold. The threshold may be configured by a BS or preconfigured or pre-defined.

Furthermore, the corresponding logical channel identifier (LCID) may be defined to identify the type of the new MAC CE. For example, a new LCID value may be defined to identify the type of the new MAC CE to indicate the new data arrival.

In another embodiment, only one LCID to indicate the new data arrival from a logical channel with a priority lower than or equal to a priority of a logical channel of the data for an SDT transmission is defined. The UE may transmit the LCID to the BS to indicate the new data arrival.

In another embodiment, a new BSR and/or a new BSR trigger condition may be defined to indicate the new data arrival.

For example, during an SDT procedure, the new data arrival with a priority equal to or lower than the priority of data for an SDT transmission can trigger a BSR. The BSR may be a legacy BSR or a new BSR (which can be represented as lower-priority-BSR-for-SDT). For example, the difference between the new BSR and the legacy BSR may be in the reserved bit. In other words, the reserved bit for the new BSR may indicate the BSR is for data with a lower priority.

Furthermore, the new BSR can only be applied in an SDT procedure. Therefore, if the UE transitions to the connected state, the BSR becomes unavailable. The new BSR can indicate at least one of a buffer status value of the new data and logical channel ID or logical channel group ID for which the priority is equal to or lower than the priority of the ongoing data (data for an SDT transmission).

In another embodiment, a RRC indication may be defined to indicate the new data arrival. The UE may transmit a RRC message to the BS to indicate the new data arrival. The RRC message has a higher priority.

Further, the RRC indication may forbid the BSR for SRB2. For example, if the new data arrival indicates the arrival of an SRB2 with a higher priority than that of the data for an SDT transmission, the UE only transmits the RRC message and forbids a BSR for the SRB2.

Further, the UE may transmit the RRC message by maintaining a legacy periodic BSR timer in RRC_CONNECTED state or configuring a new periodic BSR timer only applied in RRC_INACTIVE state.

In another embodiment, the UE may configure a RB which is allowed to be transmitted in the SDT procedure in a separate LCG or a specific priority, in order to guarantee the regular BSR to be triggered. RB may be a DRB or SRB (including SRB0, SRB1, SRB2, or SRB3). The UE transmits an indication to indicate the new data arrival by configuring a RB in a separate LCG with a higher priority than that of data for an SDT transmission or a specific priority.

For example, there are two DRBs, DRB1 and DRB2. If the DRB1 is allowed to do SDT while the DRB2 is not allowed to do SDT, the DRB1 may be configured in a separate LCG with a higher priority, or the DRB1 may be configured with a specific priority. In another example, SRB2 is allowed to be resumed, thus SRB2 may be configured in a separate LCG or configured with a specific priority.

Further, the LCG configuration for the RB in RRC_INACTIVE state (for example, SRB2 used in INACTIVE state) can be configured in a RRC release message. For example, the UE may configure the configuration of LCG after receiving a RRC release message from network.

In another embodiment, a periodic BSR timer for SDT (represented as periodicBSR-Timer-SDT) can be configured to indicate the data arrival from low or equal priority logical channel by triggering a periodic BSR during an SDT procedure. The UE may transmit a periodic BSR to indicate the new data arrival or the size of data to be transmitted by configuring the periodic BSR timer for SDT.

Further, some improvements can be made to the periodic BSR or the periodic BSR timer for SDT.

In an example, the maximum number of transmissions of the periodic BSR is configured to restrict the transmission of the periodic BSR in SDT procedure.

In another example, some restriction is added on the complete of one SDT procedure. For example, the network transmits a RRC release message to terminate the SDT procedure when the periodic BSR timer for SDT expires and there is not BSR received according to the timeline (for example, at the periodic BSR timer for SDT expiry+1slot). Thus, the UE terminates the SDT procedure after the periodic BSR timer for SDT expires and receiving a RRC release message from network.

In yet another example, the UE stops the periodic BSR timer for SDT after receiving a RRC release message from network. The starting or restarting condition for the periodic BSR timer for SDT is that at least one BSR has been triggered and not cancelled. When the periodic BSR timer for SDT expires, a BSR shall be triggered.

For the periodic BSR timer for SDT, the detail procedure may be as below:
A BSR shall be triggered if periodicBSR-Timer-SDT expires.
The MAC entity shall:
1>if the Buffer Status reporting procedure determines that at least one BSR has been triggered and not cancelled:
   . . . ;
   3>start or restart periodicBSR-Timer-SDT except when all the generated BSRs are long or short Truncated BSRs.

In some other examples, the periodic BSR timer is started, and then restarted when it expires, and can be repeated like this. Stopping the timer is not needed.

After receiving indication from the UE according to the above embodiments, the network will know the new data arrival and allocate corresponding additional resource for scheduling the new data.

Although the solutions for indicating to a BS the new data arrival with a priority equal to or lower than a priority of data for an SDT transmission during an SDT procedure are described in the above embodiments, it should be understood that, in some embodiments, the above solutions may be used to indicate the new data arrival with a higher priority than the priority of data for an SDT transmission. In addition, in some other embodiments, the above solutions may be used to indicate the new data arrival regardless of the priority of new data, that is, the above solutions can be used to indicate any new data arrival after the first SDT transmission in the SDT transmission.

In some embodiments of the present application, a cause value to indicate the RRC resume is for both SRB and DRB cause, or for both SRB and DRB data arrival, for example, the measurement report and DRB data arrival, or tracking area update (TAU) and DRB data arrival. The cause value can be a new value, or an existing value. The existing value is determined by CP message or user plane (UP) message or a specified value. For example, if the existing value is determined by CP message and the CP message is a signalling, the resume cause is determined as ‘mo-signalling’ whatever the arrived DRB data is.

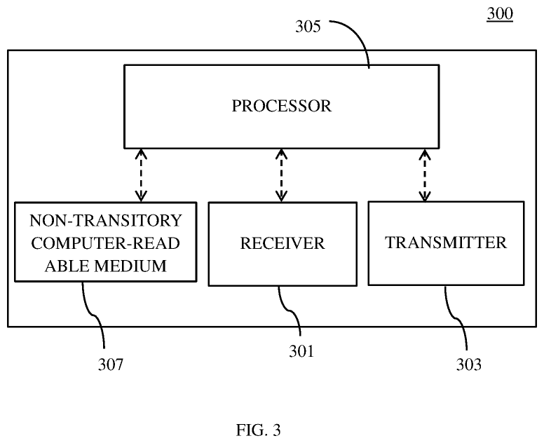

FIG. 3 illustrates a simplified block diagram of an exemplary apparatus 300 according to some embodiments of the present application. In some embodiments of the present application, the apparatus 300 may be the UE 101 as illustrated in FIG. 1 or the UE in other embodiments of the present application.

As shown in FIG. 3, the apparatus 300 may include a receiver 301, a transmitter 303, a processer 305, and a non-transitory computer-readable medium 307. The non-transitory computer-readable medium 307 has computer executable instructions stored therein. The processer 305 is configured to be coupled to the non-transitory computer readable medium 307, the receiver 301, and the transmitter 303. It can be contemplated that the apparatus 300 may include more computer-readable mediums, receiver, transmitters and processors in some other embodiments of the present application according to practical requirements. In some embodiments of the present application, the receiver 301 and the transmitter 303 can be a wireless receiver and a wireless transmitter, respectively, and can be integrated into a single device, such as a wireless transceiver. In certain embodiments, the apparatus 300 may further include an input device, a memory, and/or other components.

In some embodiments of the present application, the non-transitory computer-readable medium 307 may have stored thereon computer-executable instructions to cause the processer 305 to implement the method performed by the UE according to embodiments of the present application. For example, the processer 305 may be configured to calculate a data volume for an SDT transmission in a layer higher than an AS layer or in an AS layer; and determine to initiate an SDT procedure based on the calculated data volume being less than a data volume threshold. It should be understood that the processer 305 may be further configured to perform other operations or actions in the above description, which will not be described in detail for avoiding repetition.

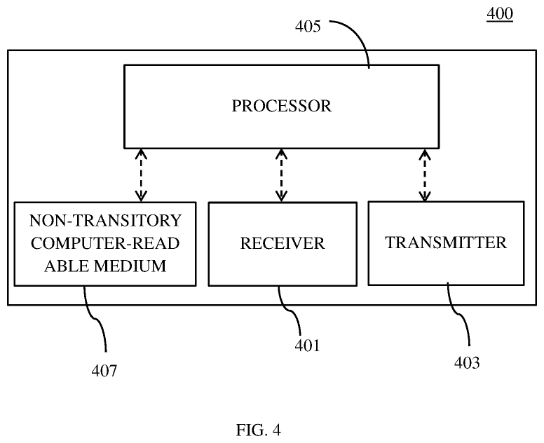

FIG. 4 illustrates a simplified block diagram of another exemplary apparatus 400 according to some embodiments of the present application. In some embodiments of the present application, the apparatus 400 may be the BS 102 as illustrated in FIG. 1 or the BS in other embodiments of the present application.

As shown in FIG. 4, the apparatus 400 may include a receiver 401, a transmitter 403, a processer 405, and a non-transitory computer-readable medium 407. The non-transitory computer-readable medium 407 has computer executable instructions stored therein. The processer 405 is configured to be coupled to the non-transitory computer readable medium 407, the receiver 401, and the transmitter 403. It is contemplated that the apparatus 400 may include more computer-readable mediums, receiver, transmitters and processors in some other embodiments of the present application according to practical requirements. In some embodiments of the present application, the receiver 401 and the transmitter 403 can be a wireless receiver and a wireless transmitter, respectively, and can be can be integrated into a single device, such as a wireless transceiver. In certain embodiments, the apparatus 400 may further include an input device, a memory, and/or other components.

In some embodiments of the present application, the non-transitory computer-readable medium 407 may have stored thereon computer-executable instructions to cause the processor 405 to implement the method performed by the BS according to embodiments of the present application.

Some embodiments of the present disclosure may be disclosed below:
Embodiment 1: A method, performed by a user equipment (UE) in a non-connected state, comprising:
   calculating a data volume for a small data transmission (SDT) transmission in a layer higher than an access stratum (AS) layer or in an AS layer; and
   determining to initiate an SDT procedure based on the calculated data volume being less than a data volume threshold.
Embodiment 2: The method of Embodiment 1, wherein the data volume includes the data volume of a signalling radio bearer (SRB) and/or a data radio bearer (DRB).
Embodiment 3: The method of Embodiment 2, wherein the UE calculates the data volume for the SRB in non-access stratum (NAS) layer, and the data volume for the SRB is at least one of a size of a NAS message, a control plane (CP) message, or a measurement report.
Embodiment 4: The method of Embodiment 2, wherein the UE calculates the data volume for the DRB in at least one of user datagram protocol (UDP) layer, internet protocol (IP) layer, transmission control protocol (TCP) layer, or application layer.
Embodiment 5: The method of Embodiment 2, wherein the data volume threshold includes at least one of a first threshold, a second threshold, and a third threshold, and the UE determines to initiate an SDT procedure based on at least one of the following:
   a sum of the data volume of the SRB and the DRB is less than the first threshold;
   the data volume of the SRB is less than the second threshold; or
   the data volume of the DRB is less than the third threshold.
Embodiment 6: The method of Embodiment 2, wherein whether to add the data volume of the SRB and the data volume of the DRB to calculate the data volume for the SDT transmission is configured or pre-defined if only one threshold is configured.
Embodiment 7: The method of Embodiment 1, wherein the UE calculates the data volume for the SDT transmission in the AS layer after receiving data size information of the SDT transmission from an upper layer by packet data convergence protocol (PDCP) layer.
Embodiment 8: The method of Embodiment 7, wherein the UE calculates the data volume for the SDT transmission by adding the data size of the SDT transmission from the upper layer to data size of header(s) associated with the AS layer.
Embodiment 9: The method of Embodiment 7, wherein the UE calculates the data volume for the SDT transmission in PDCP layer.
Embodiment 10: The method of Embodiment 1, further comprising: transmitting an indication to indicate a new data arrival with a priority equal to or lower than a priority of data for the SDT transmission after a first SDT transmission during the SDT procedure.
Embodiment 11: The method of Embodiment 10, wherein the UE transmits a media access control (MAC) control element (CE) to indicate the new data arrival.
Embodiment 12: The method of Embodiment 11, wherein a logical channel priority (LCP) of the MAC CE is lower than a priority of a MAC CE for a buffer status report (BSR) and higher than a priority of data from another logical channel.
Embodiment 13: The method of Embodiment 11, wherein the MAC CE to indicate the new data arrival includes at least one following information on the new data arrival:
   the new data arrival is for which radio bearer (RB);
   the data volume of the new data; or
   an indication to indicate whether the data volume of the new data is less than a threshold.
Embodiment 14: The method of Embodiment 11, wherein the UE further transmits a logical channel identifier (LCID) to identify a type of the MAC CE to indicate the new data arrival.
Embodiment 15: The method of Embodiment 10, wherein the UE transmits a LCID to indicate the new data arrival.
Embodiment 16: The method of Embodiment 10, wherein the UE transmits a BSR to indicate the new data arrival.
Embodiment 17: The method of Embodiment 16, wherein the BSR is triggered in the case of the new data arrival with a priority equal to or lower than the priority of data for the SDT transmission.
Embodiment 18: The method of Embodiment 16, wherein the BSR is only applied in the SDT procedure.
Embodiment 19: The method of Embodiment 16, wherein the BSR includes at least one of a buffer status value of the new data and a logical channel ID or a logical channel group (LCG) ID for which the priority is equal to or lower than the priority of data for the SDT transmission.
Embodiment 20: The method of Embodiment 10, wherein the UE transmits a radio resource control (RRC) message to indicate the new data arrival.
Embodiment 21: The method of Embodiment 20, wherein if the new data arrival indicates arrival of an SRB2 with a higher priority than that of the data for the SDT transmission, the UE only transmits the RRC message and forbids a BSR for the SRB2.
Embodiment 22: The method of Embodiment 20, wherein the UE transmits the RRC message by maintaining a first periodic BSR timer in RRC_CONNECTED state or configuring second periodic BSR timer only applied in RRC_INACTIVE state.
Embodiment 23: The method of Embodiment 10, wherein the UE transmits the indication to indicate the new data arrival by configuring a RB in a separate LCG with a higher priority than that of data for the SDT transmission or a specific priority, wherein the RB is allowed to be transmitted in the SDT procedure.
Embodiment 24: The method of Embodiment 23, wherein a configuration of the LCG is configured after receiving a RRC release message from network.
Embodiment 25: The method of Embodiment 23, wherein the RB is SRB2.
Embodiment 26: The method of Embodiment 10, wherein the UE transmits a periodic BSR to indicate the new data arrival or the size of data to be transmitted by configuring a third periodic BSR timer for SDT.
Embodiment 27: The method of Embodiment 26, wherein a maximum number of transmissions of the periodic BSR is configured to restrict the transmission of the periodic BSR in SDT procedure.
Embodiment 28: The method of Embodiment 26, wherein the UE terminates the SDT procedure after the third periodic BSR timer for SDT expires and receiving a RRC release message from network.
Embodiment 29: The method of Embodiment 26, wherein the UE stops the third periodic BSR timer for SDT after receiving a RRC release message from network.
Embodiment 30: The method of Embodiment 29, wherein the third periodic BSR timer for SDT is started or restarted when at least one BSR has been triggered and not cancelled.
Embodiment 31: The method of Embodiment 30, wherein at least one BSR is triggered when the third periodic BSR timer for SDT expires.
Embodiment 32: An apparatus, comprising:
   a processor; and
   a wireless transceiver coupled to the processor,
      wherein the processor is configured to:
      perform a method according to any one of Embodiments 1-31 with the wireless transceiver.

Persons skilled in the art should understand that as the technology develops and advances, the terminologies described in the present application may change, and should not affect or limit the principle and spirit of the present application.

Those having ordinary skill in the art would understand that the steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A method, performed by a user equipment (UE) in a non-connected state, comprising:
calculating a data volume for a small data transmission (SDT) transmission in a layer higher than an access stratum (AS) layer or in the AS layer; and
determining to initiate an SDT procedure based on the calculated data volume being less than a data volume threshold.

2. (canceled)

3. (canceled)

4. (canceled)

5. (canceled)

6. (canceled)

7. (canceled)

8. (canceled)

9. (canceled)

10. The method of claim 1, further comprising: transmitting an indication to indicate a new data arrival with a priority equal to or lower than a priority of data for the SDT transmission after a first SDT transmission in the SDT transmission during the SDT procedure.

11. (canceled)

12. (canceled)

13. (canceled)

14. (canceled)

15. A user equipment (UE), comprising:
at least one memory; and
at least one processor coupled with the at least one memory and configured to cause the UE to:
calculate a data volume for a small data transmission (SDT) transmission in a layer higher than an access stratum (AS) layer or in the AS layer; and
determine to initiate an SDT procedure based on the calculated data volume being less than a data volume threshold.

16. The UE of claim 15, wherein the data volume includes the data volume of a signalling radio bearer (SRB) and/or a data radio bearer (DRB).

17. The UE of claim 16, wherein the at least one processor is configured to cause the UE to calculate the data volume for the SRB in non-access stratum (NAS) layer, and the data volume for the SRB is at least one of a size of a NAS message, a control plane (CP) message, or a measurement report.

18. The UE of claim 16, wherein the at least one processor is configured to cause the UE to calculate the data volume for the DRB in at least one of user datagram protocol (UDP) layer, internet protocol (IP) layer, transmission control protocol (TCP) layer, or application layer.

19. The UE of claim 16, wherein the data volume threshold includes at least one of a first threshold, a second threshold, and a third threshold, and the at least one processor is configured to cause the UE to determine to initiate an SDT procedure based on at least one of:
a sum of a data volume of the SRB and the DRB is less than the first threshold;
the data volume of the SRB is less than the second threshold; or
the data volume of the DRB is less than the third threshold.

20. The UE of claim 16, wherein whether to add the data volume of the SRB and the data volume of the DRB to calculate the data volume for the SDT transmission is configured or pre-defined if only one threshold is configured.

21. The UE of claim 15, wherein the at least one processor is configured to cause the UE to calculate the data volume for the SDT transmission in the AS layer after receiving data size information of the SDT transmission from an upper layer by packet data convergence protocol (PDCP) layer.

22. The UE of claim 21, wherein the at least one processor is configured to cause the UE to calculate the data volume for the SDT transmission by adding the data size of the SDT transmission from the upper layer to data size of one or more headers associated with the AS layer.

23. The UE of claim 21, wherein the at least one processor is configured to cause the UE to calculate the data volume for the SDT transmission in the PDCP layer.

24. The UE of claim 15, wherein the at least one processor is configured to cause the UE to: transmit an indication to indicate a new data arrival with a priority equal to or lower than a priority of data for the SDT transmission after a first SDT transmission in the SDT transmission during the SDT procedure.

25. The UE of claim 24, wherein the at least one processor is configured to cause the UE to transmit a media access control (MAC) control element (CE) to indicate the new data arrival.

26. The UE of claim 25, wherein a logical channel priority (LCP) of the MAC CE is lower than a priority of a MAC CE for a buffer status report (BSR) and higher than a priority of data from another logical channel.

27. The UE of claim 25, wherein the MAC CE to indicate the new data arrival includes at least one of:
the new data arrival is for which radio bearer (RB);
a data volume of the new data; or
an indication to indicate whether the data volume of the new data is less than a threshold.

28. The UE of claim 25, wherein the at least one processor is configured to cause the UE to transmit a logical channel identifier (LCID) to identify a type of the MAC CE to indicate the new data arrival.

29. The UE of claim 24, wherein the at least one processor is configured to cause the UE to transmit a buffer status report (BSR) to indicate the new data arrival.

30. The UE of claim 15, wherein the data volume includes a data size of a kind of SRB that is configured to be allowed to do SDT.

31. The UE of claim 15, wherein the at least one processor is configured to cause the UE to calculate a data volume for one or more data radio bearer (DRBs) that are configured to be one or more DRBs for SDT.

32. A processor for wireless communication, comprising:
at least one controller coupled with at least one memory and configured to cause the processor to:
calculate a data volume for a small data transmission (SDT) transmission in a layer higher than an access stratum (AS) layer or in the AS layer; and
determine to initiate an SDT procedure based on the calculated data volume being less than a data volume threshold.
